(19) United States
(12) Patent Application Publication
(10) Pub. No.: US 2005/0012875 A1
(43) Pub. Date: Jan. 20, 2005

(54) Surface light source, method of manufacturing the same and liquid crystal display apparatus having the same

(76) Inventors: Joong-Hyun Kim, Yongin-si (KR); Ki-Yeon Lee, Suwon-si (KR); Sang-Yu Lee, Yongin-si (KR); Nam-Hun Kim, Suwon-si (KR); Hae-Soo Ha, Suwon-si (KR)

Correspondence Address: CANTOR COLBURN LLP, 55Griffin Road South, Bloomfield, CT, 06002, US

(21) Appl. No.: 10/890,363

(22) Filed: Jul. 13, 2004

(30) Foreign Application Priority Data
Jul. 16, 2003 (KR) 2003-48884
Jun. 17, 2004 (KR) 2004-44901

(51) Int. Cl. G02F 1/1335

(52) U.S. Cl. 349/70

(57) ABSTRACT

In a method of manufacturing a surface light source, a plurality of partition walls is formed on a lower substrate. The partition walls generate a first stress in the lower substrate along a first direction. A reflective layer is formed on the lower substrate. The reflective layer generates a second stress in the lower substrate along a second direction. After forming a fluorescent layer on the reflective layer and beneath an upper substrate, the upper and lower substrates are sealed to form discharge spaces between the upper and lower substrates.

### CROSS-REFERENCE TO RELATED APPLICATIONS

This application relies for priority upon Korean Patent Application No. 2003-48884 filed on Jul. 16, 2003 and No. 2004-44901 filed on Jun. 17, 2004, the contents of which are herein incorporated by reference in their entireties.

### BACKGROUND OF THE INVENTION

1. Field of the Invention

The present invention relates to a surface light source, a method of manufacturing the surface light source and a liquid crystal display apparatus having the surface light source. More particularly, the present invention relates to a surface light source having elements without deformation, a method of manufacturing the surface light source, and a liquid crystal display apparatus having the surface light source.

2. Description of the Related Art

A liquid crystal display (LCD) apparatus displays an image by using electrical and optical properties of a liquid crystal. The LCD apparatus has various characteristics, for example, such as a thin thickness, a small volume and a light weight compared with a cathode ray tube (CRT). Thus, the LCD apparatus is widely used for a portable computer, a communication device, a television set, etc.

The LCD apparatus includes a liquid crystal controlling part for controlling a liquid crystal, and a light providing part for providing the liquid crystal controlling part with a light.

Generally, the light providing part includes a cold cathode fluorescent lamp (CCFL) or a light emitting diode (LED). The CCFL is advantageous in having a high luminance, a long lifespan, a low heating value etc., and the LED has also many merits, for example, such as a low power consumption, a high luminance, etc. However, the CCFL and the LED have an non-uniform luminance.

In order to increase uniformity of luminance, the light providing part having the CCFL or the LED includes a light guide plate (LGP), a diffusion member and a prism sheet, etc. Thus, a size and a weight of a LCD apparatus having the CCFL or the LED increase.

To overcome aforementioned problems, a surface light source having a flat plate shape is disclosed. However, elements of a conventional surface light source may be deformed. The deformation may increase in proportion to a size of the surface light source.

### SUMMARY OF THE INVENTION

Therefore, regarding these disadvantages of the related arts, the present invention provides a surface light source including elements such as upper and lower substrates that have substantially no deformation.

The present invention also provides a method of manufacturing a surface light source including elements such as upper and lower substrates without deformation thereof.

The present invention also provides an LCD apparatus having a surface light source that includes elements such as upper and lower substrates without deformation thereof.

In accordance with one aspect of the present invention, a surface light source includes an upper substrate, a lower substrate corresponding to the upper substrate, a plurality of partition walls formed between the upper substrate and the lower substrate to form discharge spaces therebetween, a reflective layer formed on the lower substrate, and a fluorescent layer formed in the discharge spaces.

The surface light source may further include a voltage applying portion that applies a voltage to the discharge space. The voltage applying portion includes a plurality of electrodes that surround outer surfaces of at least one of the upper and lower substrates along a direction substantially perpendicular to a longitudinal direction of the partition wall.

The partition walls generate a first stress in the lower substrate along a first direction, whereas the reflective layer generates a second stress in the lower substrate along a second direction. The first direction is opposed to the second direction so that the first stress of the lower substrate is compensated by the second stress of the lower substrate. The first stress is generated in accordance with a difference between a thermal expansion coefficient of the lower substrate and a thermal expansion coefficient of the partition walls, and the second stress is generated in accordance with a difference between the thermal expansion coefficient of the lower substrate and a thermal expansion coefficient of the reflective layer. Preferably, the difference between the thermal expansion coefficient of the lower substrate and the thermal expansion coefficient of the partition walls is substantially identical to the difference between the thermal expansion coefficient of the lower substrate and the thermal expansion coefficient of the reflective layer. Namely, one thermal expansion coefficient of the partition walls and the reflective layer is about 80 to about 100 percent of the thermal expansion coefficient of the lower substrate, and the other thermal expansion coefficient of the partition walls and the reflective layer is about 100 to about 120 percent of the thermal expansion coefficient of the lower substrate.

In accordance with another aspect of the present invention, a method of manufacturing a surface light source includes a plurality of partition walls formed on a lower substrate. The partition walls generate a first stress in the lower substrate along a first direction. A reflective layer is formed on the lower substrate. The reflective layer generates a second stress in the lower substrate along a second direction. A fluorescent layer is formed on the reflective layer and beneath an upper substrate. The upper substrate and the lower substrate are sealed to form discharge spaces between the upper substrate and the lower substrate.

A voltage applying portion that applies a voltage to the discharge space may be formed. The voltage applying portion includes a plurality of electrodes that surround outer surfaces of at least one of the upper and lower substrates along a direction substantially perpendicular to a longitudinal direction of the partition wall.

In accordance with still another aspect of the present invention, an LCD apparatus includes a surface light source that includes an upper substrate, a lower substrate corresponding to the upper substrate, a plurality of partition walls formed between the upper substrate and the lower substrate to form discharge spaces, a reflective layer formed on the lower substrate and a fluorescent layer formed in the discharge spaces, a liquid crystal display panel that displays images by using a light emitted from the surface light source, and a receiving container that receives the surface light source and the liquid crystal display panel. The partition walls generate a first stress in the lower substrate along a first direction and the reflective layer generates a second stress in the lower substrate along a second direction.

According to the present invention, a stress generated in a lower substrate having the partition walls in a process for forming the partition walls may be completely compensated by a stress generated in the lower substrate having the partition walls and a reflective layer in a process for forming the reflective layer. Therefore, deformation of the lower substrate including partition walls, the reflective layer, and the dielectric layer may be prevented due to precisely adjusted thermal expansion coefficient differences among the lower substrate, the partition walls, the reflective layer, etc. In addition, because an upper substrate is formed over the lower substrate, the upper substrate may have a level structure without deformation thereof. Further, when a surface light source has an enlarged size, the surface light source may have elements such as the lower substrate, the upper substrate, the partition walls and the reflective layer without deformation of those elements by precisely adjusting the thermal expansion coefficient differences among those elements.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a partially cut perspective view illustrating a surface light source in accordance with one embodiment of the present invention;

FIG. 2 is a cross-sectional view illustrating the surface light source taken along a line of II-II′ in FIG. 1;

FIG. 3 is a cross-sectional view illustrating the surface light source taken along a line of II-II′ in FIG. 1;

FIGS. 4 and 5 are cross-sectional views illustrating a method of manufacturing a surface light source in accordance with one embodiment of the present invention;

FIG. 6 is a flow chart illustrating the method of manufacturing the surface light source in accordance with one embodiment of the present invention; and

FIG. 7 is an exploded perspective view illustrating a liquid crystal display apparatus having the surface light source of FIG. 1.

### DESCRIPTION OF PREFERRED EMBODIMENTS

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the thickness of layers and regions are exaggerated for clarity. Like reference numerals refer to similar or identical elements throughout. It will be understood that when an element such as a layer, region or substrate is referred to as being “on” or “onto” another element, it may be directly on the other element or intervening elements may also be present.

A surface light source includes upper and lower substrates having glass, a plurality of partition walls for providing discharge spaces between the upper and lower substrates, a reflective layer formed on the lower substrate, a fluorescent layer formed in the discharge spaces, and electrodes for inducing plasma discharging in the discharge spaces to thereby generate visible rays from the fluorescent layer that is excited by the plasma discharging.

As for the surface light source, since the partition walls and the reflective layer may be formed on the lower substrate or beneath the upper substrate by a firing process at a high temperature, thermal expansion coefficient of each of elements included in the surface light source should be properly adjusted so as to prevent deformation of the upper and lower substrates. That is, the thermal expansion coefficients of the partition walls and the reflective layer should get near those of the upper and lower substrates.

However, in the surface light source including the partition walls and the reflective layer formed on the lower substrate or beneath the upper substrate by the high temperature firing process, all the elements of the surface light source may have different thermal expansion coefficients from one another, thereby causing the deformation of the upper and lower substrates. The deformation of the upper and lower substrates increases proportional to an amount of difference between the thermal expansion coefficients of the elements. The amount of the deformation increases in proportion to a size of the surface light source.

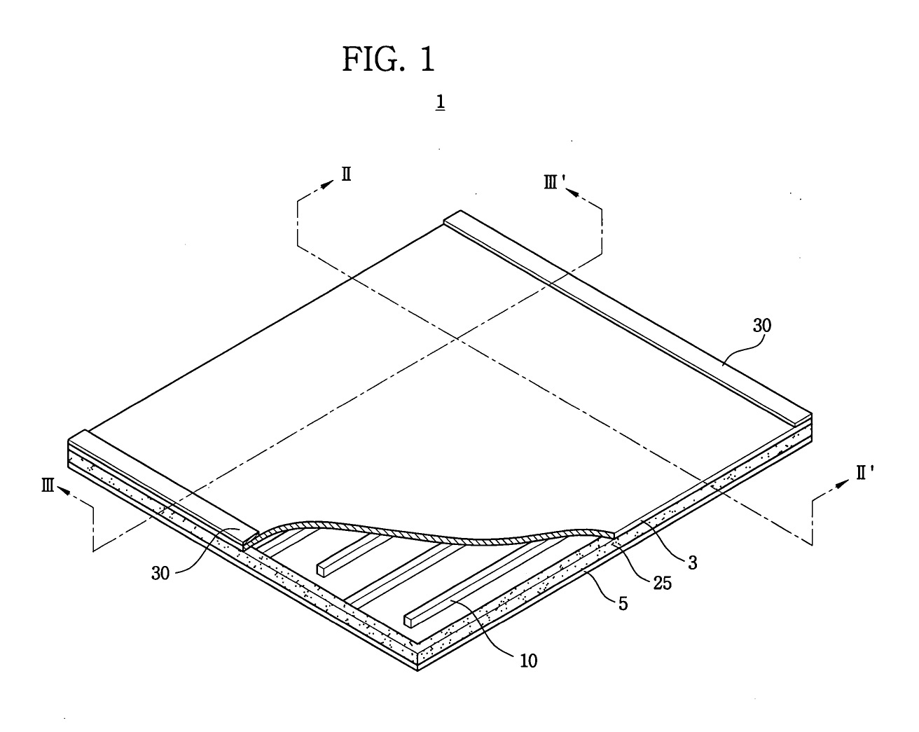

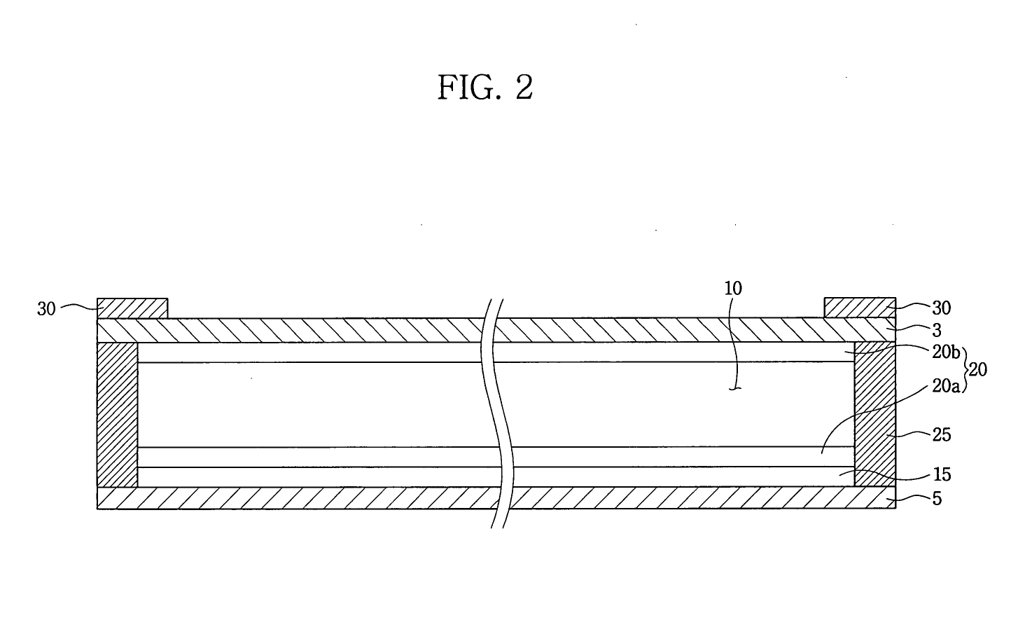

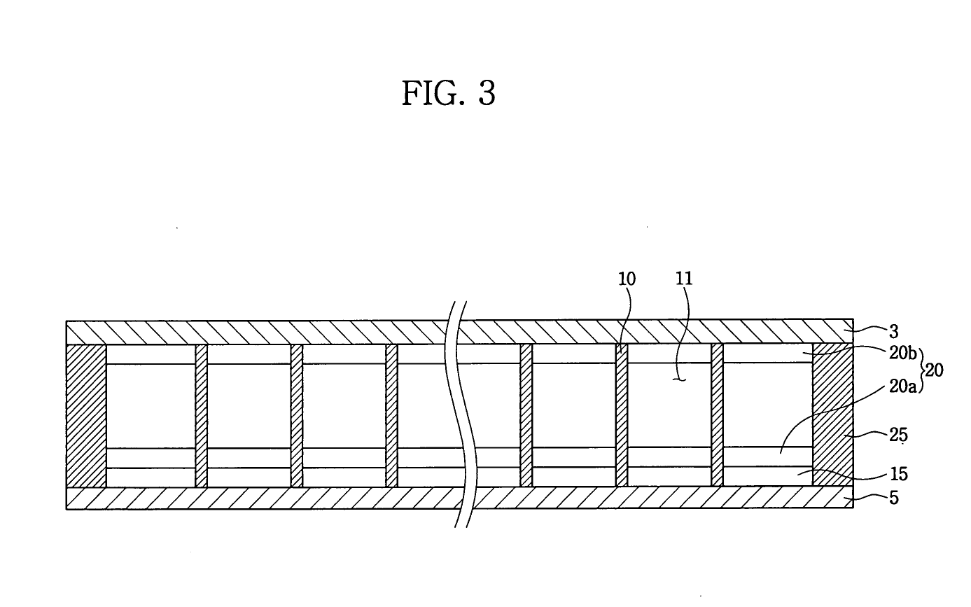

FIG. 1 is a partially cut perspective view illustrating a surface light source in accordance with one embodiment of the present invention, FIG. 2 is a cross-sectional view illustrating the surface light source taken along a line of II-II′ in FIG. 1, and FIG. 3 is a cross-sectional view illustrating the surface light source taken along a line of III-III′ in FIG. 1.

Referring to FIGS. 1 to 3, a surface light source 1 of the present embodiment includes an upper substrate 3, a lower substrate 5, a plurality of partition walls 10, a reflective layer 15, a fluorescent layer 20, a sealing member 25, and electrodes 30.

The upper substrate 3 may be formed using transparent material such as glass. The lower substrate 5 faces the upper substrate 3 with a predetermined distance.

The partition walls 10 are disposed between the upper substrate 3 and the lower substrate 5 by substantially identical intervals so that a plurality of discharge spaces 11 are provided between the upper substrate 3 and the lower substrate 5 in accordance with formation of the partition walls 10.

The reflective layer 15 is formed on the lower substrate 5.

The fluorescent layer 20 includes a first fluorescent layer 20a and a second fluorescent layer 20b. The first fluorescent layer 20a is formed on the reflective layer 15, and the second fluorescent layer 20b is formed on the upper substrate 3. The partition walls 10, the reflective layer 15 and the fluorescent layer 20 may be formed on the lower substrate 5 by firing processes.

A plurality of the electrodes 30 surround outer surfaces of both sides of at least one of the upper and lower substrates 3 and 5 along a direction substantially perpendicular to a longitudinal direction of the partition wall 10. The electrodes 30 apply electric fields to the discharge spaces 11 that cause plasma discharge therein, thereby exciting a fluorescent material included in the fluorescent layer 20. As a result, the fluorescent material of the fluorescent layer 20 generates lights.

In the present embodiment, one element between the partition walls 10 and the reflective layer 15 has a thermal expansion coefficient substantially smaller than that of the lower substrate 5, whereas the other element between the partition walls 10 and the reflective layer 15 has a thermal expansion coefficient substantially larger than that of the lower substrate 5. For example, when the partition walls 10 have a thermal expansion coefficient substantially smaller than that of the lower substrate 5, the reflective layer 15 has a thermal expansion coefficient substantially larger than that of the lower substrate 5, and vice versa. Here, an absolute value of difference between the thermal expansion coefficient of the partition walls 10 and the thermal expansion coefficient of the lower substrate 5 may be substantially identical to an absolute value of difference between the thermal expansion coefficient of the reflective layer 15 and the thermal expansion coefficient of the lower substrate 5.

The thermal expansion coefficients of the partition walls 10 and the reflective layer 15 may preferably be in a range of about 80 to about 120 percent of that of the lower substrate 5. Particularly, one element between the partition walls 10 and the reflective layer 15 has a thermal expansion coefficient in a range of about 80 to about 100 percent of that of the lower substrate 5, whereas the other element between the partition walls 10 and the reflective layer 15 has a thermal expansion coefficient in a range of about 100 to about 120 percent of that of the lower substrate 5. For example, when the partition walls 10 have a thermal expansion coefficient in a range of about 80 to about 100 percent of that of the lower substrate 5, the reflective layer 15 has a thermal expansion coefficient in a range of about 100 to about 120 percent of that of the lower substrate 5. On the contrary, the partition walls 10 have a thermal expansion coefficient in a range of about 100 to about 120 percent that of the lower substrate 5 when the reflective layer 15 has a thermal expansion coefficient in a range of about 80 to about 100 percent that of the lower substrate 5. As described above, the absolute value of difference between the thermal expansion coefficient of the partition walls 10 and the thermal expansion coefficient of the lower substrate 5 may be substantially identical to the absolute value of difference between the thermal expansion coefficient of the reflective layer 15 and the thermal expansion coefficient of the lower substrate 5.

In the present invention, since the lower substrate 5, the partition walls 10 and the reflective layer 15 have precisely adjusted thermal expansion coefficients, deformation of the lower substrate 5 may be prevented in accordance with minimization of stress that is applied to the lower substrate 5 and generated in processes for manufacturing the surface light source 1. For example, when the partition walls 10 have the thermal expansion coefficient larger than that of the lower substrate 5 and the reflective layer 15 has the thermal expansion coefficient smaller than that of the lower substrate 5, the lower substrate 5 including the partition walls 10 may have a first stress generated along a first direction so that the lower substrate 5 including the partition walls 10 may be warped in a direction substantially parallel to a position where the partition walls 10 are positioned after forming the partition walls 10 on the lower substrate 5. When the reflective layer 15 is subsequently formed on the lower substrate 5, the lower substrate 5 including the reflective layer 15 may have a second stress generated along a second direction substantially perpendicular to the first direction such that the lower substrate 5 including the reflective layer 15 may be warped in a direction opposed to a position where the reflective layer 15 is formed. That is, the first stress generated in a process for forming the partition walls 10 on the lower substrate 5 may be compensated by the second stress generated in a process for forming the reflective layer 15 on the lower substrate 5. Alternatively, when the partition walls 10 has the thermal expansion coefficient smaller than that of the lower substrate 5 and the reflective layer 15 has the thermal expansion coefficient larger than that of the lower substrate 5, the lower substrate 5 including the partition walls 10 may have a first stress generated along a first direction so that the lower substrate 5 including the partition walls 10 may be warped in a direction opposed to the position of the partition walls 10 after the partition walls 10 are formed on the lower substrate 5. When the reflective layer 15 is subsequently formed on the lower substrate 5, the lower substrate 5 including the reflective layer 15 may have a second stress generated along a second direction substantially perpendicular to the first direction such that the lower substrate 5 including the reflective layer 15 may be warped in a direction substantially parallel to the position of the reflective layer 15. As described above, the first stress generated in a process forming the partition walls 10 on the lower substrate 5 may be compensated by the second stress generated in a process for forming the reflective layer 15 on the lower substrate 5. As a result, deformation of the lower substrate 5 may be effective prevented by precisely adjusting the stresses generated due to the differences of the thermal expansion coefficients of the lower substrate 5, the partition walls 10 and the reflective layer 15.

The upper substrate 3 has a rectangular plate shape. The lower substrate 5 may include transparent material such as glass and has a rectangular plate shape substantially identical to that of the upper plate 3. That is, the upper and lower substrates 3 and 5 may have substantially identical sizes and materials. The upper substrate 3 may have a thermal expansion coefficient of about 0.0000050 to about 0.0000150/° C., and also the lower substrate 5 may have a thermal expansion coefficient of about 0.0000050 to about 0.0000150/° C. For example, the upper and lower substrates 3 and 5 are formed using soda lime glass.

The sealing member 25 is formed between a peripheral portion of the upper substrate 3 and a peripheral portion of the lower substrate 5 to seal the discharge spaces 11 provided between the upper and lower substrates 3 and 5. For example, the sealing member 25 has a rectangular frame shape having a size substantially identical to those of the upper and lower substrates 3 and 5.

The partition walls 10 are positioned on the lower substrate 5 by the identical intervals. The partition walls 10 may be formed using material having a viscosity such as clay or ceramic. After viscous materials having predetermined shapes are formed on the lower substrate 5, the lower substrate 5 including the viscous materials thereon is thermally treated by a firing process at a high temperature, thereby forming the partition walls 10 on the lower substrate 5. Hereinafter, the firing process for forming the partition walls 10 is referred to as “a partition firing process”.

The partition walls 10 are disposed substantially in parallel to one another. In the present embodiment, each of the partition walls 10 may not make contact with the sealing member 25 formed between the peripheral portions of the upper and lower substrates 3 and 5 so that the discharge spaces 11 defined by the partition walls 10 are partially connected to one another.

In the partition wall firing process, after forming the viscous materials are formed on the lower substrate 5, the lower substrate 5 including the viscous materials thereon is sintered at the high temperature. When the lower substrate 5 including the viscous materials is sintered at the high temperature, liquid ingredients included in the viscous materials are evaporated from the viscous material, thereby forming the partition walls 10 on the lower substrate 5.

When the lower substrate 5 including the partition walls 10 is cooled at a room temperature, the first stress is generated in the lower substrate 5 including the partition walls 10 along the first direction because the partition walls 10 has the thermal expansion coefficient different from that of the lower substrate 5. Thus, the lower substrate 5 including the partition walls 10 may be warped along the direction opposed to the position where the partition walls 10 or substantially parallel to the position where the partition walls 10 are formed. For example, when the partition walls 10 have the thermal expansion coefficient larger than that of the lower substrate 5, the entire lower substrate 5 including the partition walls 10 is concavely warped after cooling the lower substrate 5 including the partition walls 10 because a shrinkage amount of the partition walls 10 is larger than that of the lower substrate 5. On the contrary, when the partition walls 10 have the thermal expansion coefficient smaller than that of the lower substrate 5, the entire lower substrate 5 including the partition walls 10 is convexly warped after cooling the lower substrate 5 including the partition walls 10 because a shrinkage amount of the partition walls 10 is smaller than that of the lower substrate 5.

The reflective layer 15 is formed on the lower substrate 5 including the partition walls 10. The reflective layer 15 is formed on the lower substrate 5 by coating reflective material on the lower substrate 5 and firing the lower substrate 5 including the reflective material at a high temperature. Hereinafter, a firing process for forming the reflective layer 15 is referred to as “reflective layer firing process”.

After the fluorescent layer 20 generates lights, the reflective layer 15 reflects the lights directing to the lower substrate 5 toward the upper substrate 3 to thereby minimize loss of the lights generated from the fluorescent layer 20.

In the reflective layer firing process, after reflective material having a liquid phase is coated on the concavely or convexly bent lower substrate 5 including the partition walls 10, the lower substrate 5 including the reflective material is thermally treated at the high temperature. When liquid ingredients included in the reflective material are evaporated at the high temperature, the reflective layer 15 is formed on the lower substrate 5. When the lower substrate 5 including the reflective layer 15 is cooled at a room temperature, the concavely or convexly bent lower substrate 5 including the reflective layer 15 may be convexly or concavely warped again. As a result, the lower substrate 5 including the partition walls 10 and the reflective layer 15 entirely has a level state. Although the partition walls 10 are primarily formed on the lower substrate 5 and the reflective layer 15 is secondarily formed on the lower substrate 5 including the partition walls 10, the reflective layer 15 may be primarily formed on the lower substrate 5 and the partition walls may be secondarily formed on the lower substrate 5 including the partition walls 10.

The fluorescent layer 20 is formed beneath the upper substrate 3 and on the reflection layer 15 positioned in the discharge spaces 11 provided between the partition walls 10. The fluorescent layer 20 generates visible rays in accordance with an electric field applied from the electrodes 30 disposed on the upper and lower substrates 3 and 5.

The electrodes 30 generate the electric field in the discharge spaces 11 to induce plasma discharging after the electrodes 30 receive current from outside. Ultraviolet rays generated by the plasma discharging in the discharging spaces 11 may excite fluorescent material included in the fluorescent layer 20 so that the fluorescent layer 20 emits the visible rays therefrom.

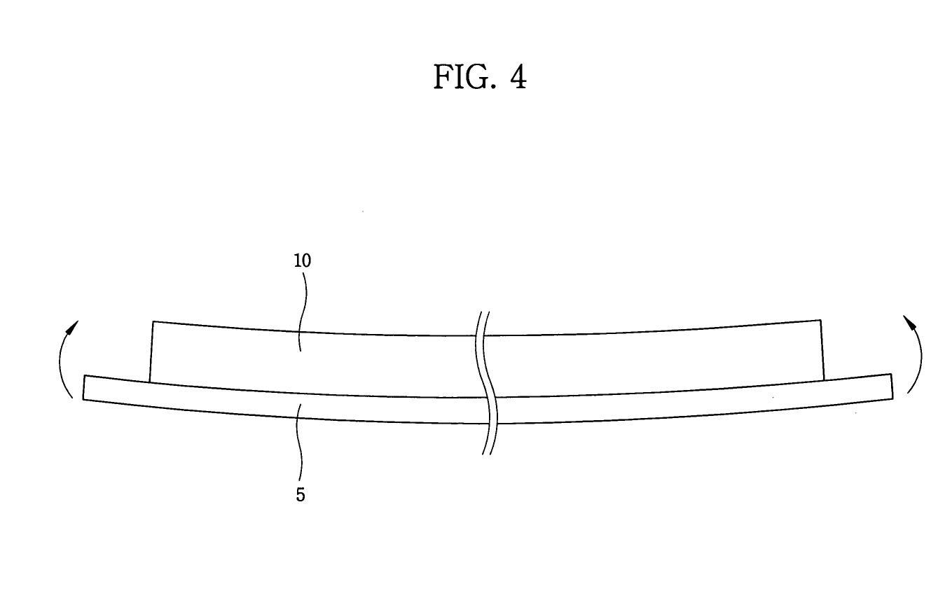

Hereinafter, a method of manufacturing the surface light source having the above-described construction will be described with reference to FIGS. 4 to 6.

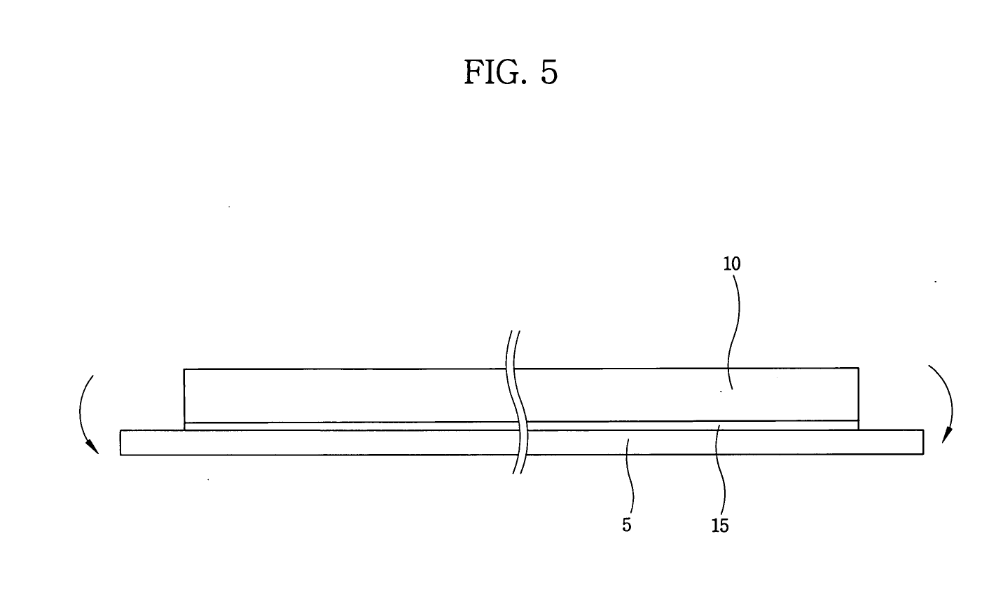

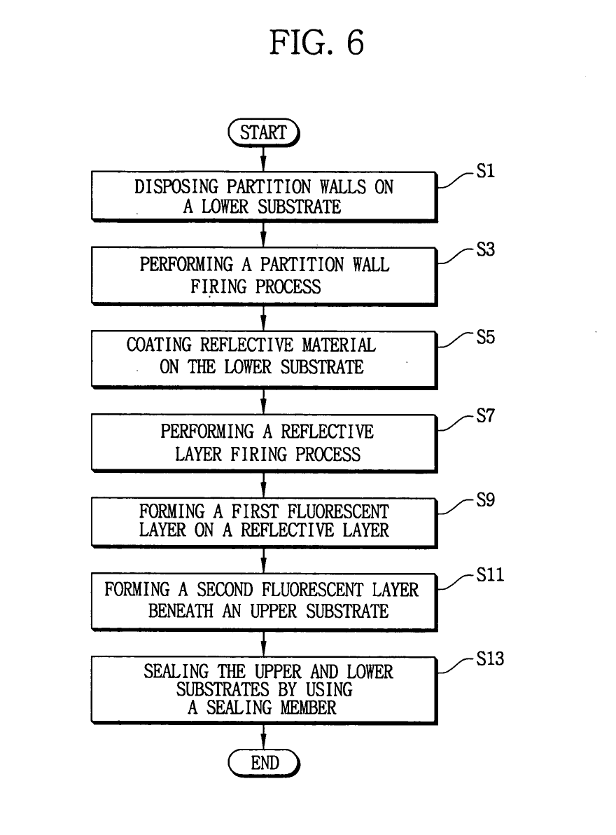

FIGS. 4 and 5 are cross-sectional views illustrating a method of manufacturing a surface light source in accordance with one embodiment of the present invention, and FIG. 6 is a flow chart illustrating the method of manufacturing the surface light source in accordance with one embodiment of the present invention.

In this embodiment, the lower substrate 5 has a thermal expansion coefficient of about 0.0000085/° C., the partition walls 10 have a thermal expansion coefficient of about 0.0000090/° C., and the reflective layer 15 has a thermal expansion coefficient of about 0.0000078/° C. Here, the lower substrate 5 has a length of about 700 mm.

Referring to FIGS. 4 to 6, in step S1, the partition walls 10 are positioned on the lower substrate 5 to form the discharge spaces 11 between the upper substrate 3 and the lower substrate 5. Using the partition wall firing process, the partition walls 10 are completely formed on the lower substrate 5 in step S3. Since the partition walls 10 have the thermal expansion coefficient larger than that of the lower substrate 5, a first stress is generated in the lower substrate 5 along a first direction so that the lower substrate 5 having the partition walls 10 is concavely bent along the direction substantially parallel to the position of the partition walls 10. That is, the lower substrate 5 including the partition walls 10 is upwardly warped.

After coating the reflective material on the lower substrate 5 including the partition walls 10 in step S5, the reflective layer 15 is formed on the lower substrate 5 among the partition walls 10 by the reflective layer firing process in step S7. Because the reflective layer 15 has the thermal expansion coefficient smaller than that of the lower substrate 5, a second stress is generated in the lower substrate 5 along a second direction opposed to the first direction such that the lower substrate 5 including the partition walls and the reflective layer 15 is convexly bent along a direction opposed to a position of the reflective layer 15. Namely, the lower substrate 5 including the partition walls 10 and the reflective layer 15 is downwardly warped. Since thermal expansion coefficient difference between the partition walls 10 and the lower substrates is substantially identical to thermal expansion coefficient difference between the lower substrate 5 and the reflective layer 15. Therefore, the first stress may be completely compensated by the second stress so that the lower substrate 5 including the partition walls 10 and the reflective layer 15 has a level structure. Although the lower substrate 5 including the partition walls 10 is upwardly warped after performing the partition wall firing process, the lower substrate 5 including the partition walls 10 and the reflective layer 15 is downwardly warped by the reflective layer firing process, thereby planarizing the lower substrate 5 having is the partition walls 10 and the reflective layer 15.

Referring to FIG. 6, the fluorescent material is coated on the reflective layer 15 in the discharge spaces 11 among the partition walls 10 to thereby form the first fluorescent layer 20a on the reflective layer 15 in step S9.

After the fluorescent material is coated beneath the upper substrate 3 to thereby form the second fluorescent layer 20b beneath the upper substrate 3 in step S11, the sealing member 25 is attached to the peripheral portions of the upper and lower substrates 3 and 5 to seal the discharge spaces 11 in step S13.

A voltage applying portion that applies a voltage to the discharge space may be formed. The voltage applying portion may be formed by forming a plurality of electrodes 30. That is, the electrodes 30 may surround outer surfaces of both sides of at least one of the upper and lower substrates 3 and 5 along a direction substantially perpendicular to a longitudinal direction of the partition wall 10. When the electric field is applied to the discharge spaces 11 from the electrodes 30, the plasma discharging is induced in the discharge spaces 11 to generate the ultraviolet rays. The ultraviolet rays excite the fluorescent material included in the fluorescent layer 20 so that the fluorescent layer 20 generates the visible rays therefrom.

In one embodiment of the present invention, when the reflective layer 15 has a thermal expansion coefficient larger than that of the lower substrate 5 by about 20 percent and the partition walls 10 has a thermal expansion coefficient smaller than that of the lower substrate 5 by about 20 percent, the lower substrate 5 including the partition walls 10 and the reflective layer 15 has substantially level structure after performing the partition wall firing process and the reflective layer firing process.

In this exemplary embodiment, the partition firing process and the reflective layer firing process are performed as separate processes. Alternatively, the partition firing process and the reflective layer firing process may be performed as a single process.

In this exemplary embodiment, although the upper substrates 3 may have a flat plate shape as shown in FIGS. 1 to 3, alternatively, the upper substrate 3 has a plurality of semi-cylindrical shapes that are successively formed. Then, a surface light source 1 may not include the partition walls 10, but the upper substrate 3 having the semi-cylindrical shape successively formed functions as the partition walls 10. When the surface light source 1 has the above-mentioned structure, the deformation of the lower substrate 5 may be prevented by precisely adjusted thermal expansion coefficient differences among the lower substrate 5, the reflective layer 15 and the upper substrate 3 having the semi-cylindrical shape successively formed, not by precisely adjusted thermal expansion coefficient differences among the lower substrate 5, the reflective layer 15 and the partition walls 10.

Furthermore, when another layer is additionally formed on the lower substrate 5 by firing process, a stress generated in a lower substrate during the formation of the partition walls 10, reflective layer 15, etc. may be compensated by a stress generated in the lower substrate 5 during the formation of the additionally formed layer. Therefore, the deformation of the lower substrate 5 including the additionally formed layer may be prevented. The additionally formed layer may be, for example, the fluorescent layer 20, a protective layer (not shown), and so on. The protective layer may be an organic protective layer, an inorganic protective layer, a passivation layer, an overcoating layer, etc.

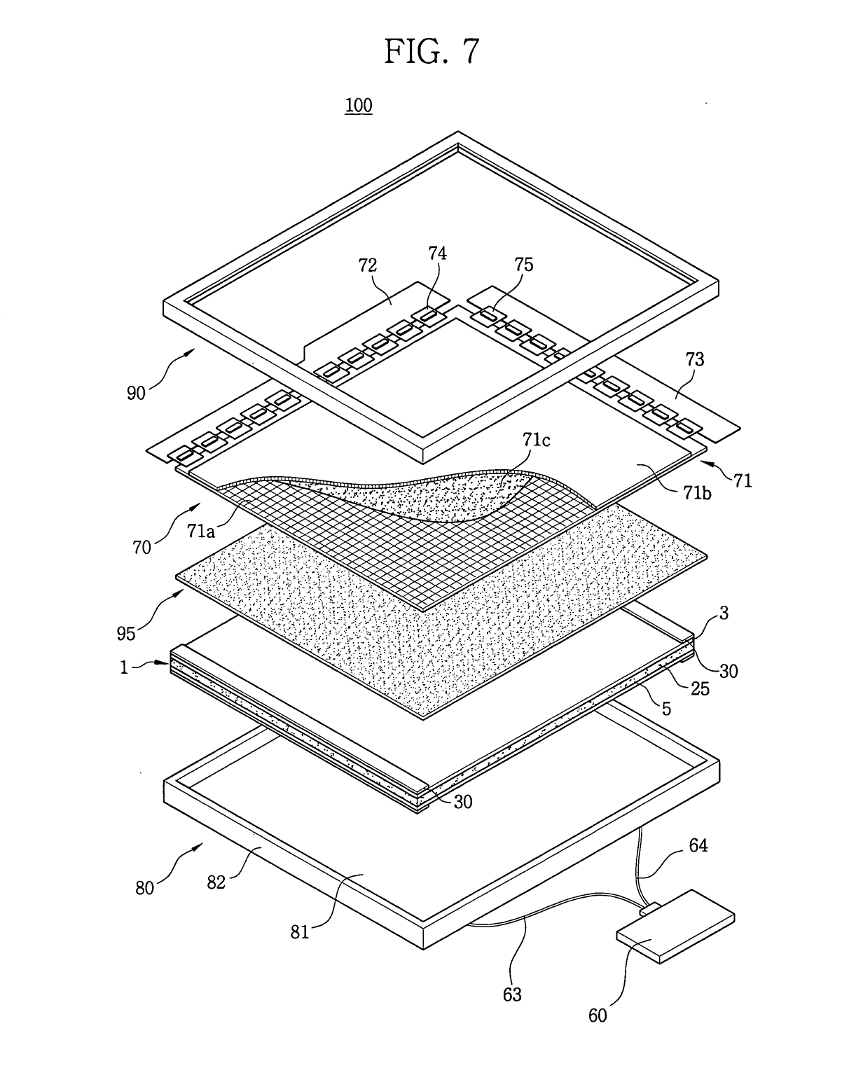

FIG. 7 is an exploded perspective view illustrating an LCD apparatus having a surface light source in accordance with an exemplary embodiment of the present invention.

Referring to FIG. 7, an LCD apparatus 100 includes a surface light source 10, a display unit 70 and a receiving container 80.

The surface light source 1 includes an upper substrate 3, a lower substrate 5, a plurality of partition walls (not shown), a reflective layer (not shown), a fluorescent layer (not shown), a sealing member 25 and a plurality of electrodes 30. The surface light source 1 applied in the present embodiment is same as in FIG. 1. Thus, any further explanation will be omitted.

The display unit 70 includes an LCD panel 71, a data printed circuit board (PCB) 72 that provides a driving signal for driving the LCD panel 71, and a gate PCB 73. The data and the gate PCBs 72 and 73 are electrically connected to the LCD panel 71 through a data tape carrier package (TCP) and a gate TCP, respectively.

The LCD panel 71 includes a thin film transistor (TFT) substrate 71a, a color filter substrate 71b disposed at a position corresponding to the TFT substrate 71a, and liquid crystal 71c interposed between the two substrates 71a and 71b.

The TFT substrate 71a is a transparent glass substrate where TFTs (not shown) and switching elements are formed in a matrix shape. A data and a gate lines are connected to a source electrode and a gate electrode of the TFTs respectively, and a pixel electrode (now shown) is connected to a drain electrode. The pixel electrode includes transparent conductive material.

Color pixels such as red (R), green (G), blue (B) pixels are formed on the color filter substrate 71b through the thin film process. In addition, a common electrode (not shown) may be formed on the color filter substrate 71b. The common electrode includes transparent conductive material.

The receiving container 80 includes a bottom surface 81 and a plurality of sidewalls 82 that forms a receiving space. The receiving container 80 fixes the surface light source 1 and the LCD panel 71 so as to prevent drifting of the surface light source 1 and the LCD panel 71.

The bottom surface 81 has a sufficient bottom area, so that the surface light source 100 is mounted thereon, and may have the same shape as the surface light source 1. The sidewall 82 extends substantially perpendicular to the bottom surface 81 from an edge portion of the bottom surface 81.

An LCD apparatus 100 in accordance with another embodiment of the present invention further includes an inverter 60 and a top chassis 90.

The inverter 60 is disposed outside the receiving container 80 to generate a discharge voltage for driving the surface light source 1. The discharge voltage generated from the inverter 60 is applied to the surface light source 1 through a first power supply cable 63 and a second power supply cable 64. The first and second power supply cables 63 and 64 may be connected to an electrode 30. Alternatively, the first and second power supply cables 63 and 64 may also be connected to the electrode 30 through a separated connection member (not shown).

The top chassis 90 is combined with the receiving container 80 surrounding edge portions of the LCD panel 71. The top chassis 90 protect the LCD panel 71 from an impact that is provided from an exterior to the LCD apparatus 100. The top chassis 90 combines the LCD panel 71 with the receiving container 80.

The LCD apparatus 100 may further include at least one optical sheet 95. The optical sheet 95 may include a diffusion sheet for diffusing a light or a prism sheet for increasing a luminance of the light.

The LCD apparatus 100 may further include mold frame (not shown) disposed between the surface light source 1 and the optical sheet 95. The electrode 30 of surface light source 1 may not make contact with a conductive material by the mold frame. The mold frame may support the optical sheet 95 to prevent drifting of the optical sheet 95.

According to the present exemplary embodiment, as for the LCD apparatus including the lower substrate, the upper substrate, the partition walls and the reflective layer, deformation of the lower substrate, the upper substrate, the partition walls and the reflective layer is decreased. According to the present invention, a stress generated in a lower substrate having the partition walls in a process for forming the partition walls may be completely compensated by a stress generated in the lower substrate having the partition walls and a reflective layer in a process for forming the reflective layer. Therefore, deformation of the lower substrate including partition walls and the reflective layer may be prevented due to precisely adjusted thermal expansion coefficient differences among the lower substrate, the partition walls and the reflective layer. In addition, because an upper substrate is formed over the level lower substrate, the upper substrate may have a level structure without deformation thereof. Further, when a surface light source has an enlarged size, the surface light source may have elements such as the lower substrate, the upper substrate, the partition walls and the reflective layer without deformation of those elements by precisely adjusting the thermal expansion coefficient differences among those elements.

Having described the preferred embodiments for forming the present invention, it is noted that modifications and variations can be made by persons skilled in the art in light of the above teachings. It is therefore to be understood that changes may be made in the particular embodiment of the present invention disclosed which is within the scope and the spirit of the invention outlined by the appended claims. For example, when another layer is additionally formed on a lower substrate by firing process, a stress generated in a lower substrate during the formation of the partition walls, reflective layer, etc. may be compensated by a stress generated in the lower substrate during the formation of the additionally formed layer. Therefore, the deformation of the lower substrate including the additionally formed layer may be prevented.

1. A surface light source comprising:
an upper substrate;
a lower substrate corresponding to the upper substrate;
a plurality of partition walls formed between the upper substrate and the lower substrate to form discharge spaces between the upper substrate and the lower substrate, the partition walls generating a first stress in the lower substrate along a first direction;
a reflective layer formed on the lower substrate, the reflective layer generating a second stress in the lower substrate along a second direction; and
a fluorescent layer formed in the discharge spaces.

2. The surface light source of claim 1, wherein the first direction is opposed to the second direction.

3. The surface light source of claim 2, wherein the first stress of the lower substrate is compensated by the second stress of the lower substrate.

4. The surface light source of claim 3, wherein the lower substrate has a substantially level structure.

5. The surface light source of claim 1, wherein the first stress is generated in accordance with a difference between a thermal expansion coefficient of the lower substrate and a thermal expansion coefficient of the partition walls.

6. The surface light source of claim 5, wherein the second stress is generated in accordance with a difference between the thermal expansion coefficient of the lower substrate and a thermal expansion coefficient of the reflective layer.

7. The surface light source of claim 6, wherein the difference between the thermal expansion coefficient of the lower substrate and the thermal expansion coefficient of the partition walls is substantially identical to the difference between the thermal expansion coefficient of the lower substrate and the thermal expansion coefficient of the reflective layer.

8. The surface light source of claim 6, wherein the thermal expansion coefficient of the partition walls is about 80 to about 100 percent of the thermal expansion coefficient of the lower substrate, and the thermal expansion coefficient of the reflective layer is about 100 to about 120 percent of the thermal expansion coefficient of the lower substrate.

9. The surface light source of claim 6, wherein the thermal expansion coefficient of the partition walls is about 100 to about 120 percent of the thermal expansion coefficient of the lower substrate, and the thermal expansion coefficient of the reflective layer is about 80 to about 100 percent of the thermal expansion coefficient of the lower substrate.

10. The surface light source of claim 6, wherein a thermal expansion coefficient of the upper substrate is substantially identical to thermal expansion coefficient of the lower substrate.

11. The surface light source of claim 1, further comprising a voltage applying portion that applies a voltage to the discharge space.

12. The surface light source of claim 11, wherein the voltage applying portion comprises a plurality of electrodes that surround outer surfaces of at least one of the upper and lower substrates along a direction substantially perpendicular to a longitudinal direction of the partition wall.

13. A method of manufacturing a surface light source comprising:
forming a plurality of partition walls on a lower substrate, the partition walls generating a first stress in the lower substrate along a first direction;
forming a reflective layer on the lower substrate, the reflective layer generating a second stress in the lower substrate along a second direction;
forming a fluorescent layer on the reflective layer and beneath an upper substrate; and
sealing the upper substrate and the lower substrate to form discharge spaces between the upper substrate and the lower substrate.

14. The method of claim 13, wherein the first direction is opposed to the second direction, and the first stress of the lower substrate is compensated by the second stress of the lower substrate.

15. The method of claim 14, wherein the first stress is generated in accordance with a difference between a thermal expansion coefficient of the lower substrate and a thermal expansion coefficient of the partition walls, and the second stress is generated in accordance with a difference between the thermal expansion coefficient of the lower substrate and a thermal expansion coefficient of the reflective layer.

16. The method of claim 15, wherein the difference between the thermal expansion coefficient of the lower substrate and the thermal expansion coefficient of the partition walls is substantially identical to the difference between the thermal expansion coefficient of the lower substrate and the thermal expansion coefficient of the reflective layer.

17. The method of claim 15, wherein one thermal expansion coefficient of the partition walls and the reflective layer is about 80 to about 100 percent of the thermal expansion coefficient of the lower substrate, and the other thermal expansion coefficient of the partition walls and the reflective layer is about 100 to about 120 percent of the thermal expansion coefficient of the lower substrate

18. The method of claim 13, further comprising forming a voltage applying portion that applies a voltage to the discharge space.

19. The method of claim 18, wherein the voltage applying portion comprises a plurality of electrodes that surround outer surfaces of at least one of the upper and lower substrates along a direction substantially perpendicular to a longitudinal direction of the partition wall.

20. A liquid crystal display apparatus comprising:
a surface light source that comprises an upper substrate, a lower substrate corresponding to the upper substrate, a plurality of partition walls formed between the upper substrate and the lower substrate to form discharge spaces, a reflective layer formed on the lower substrate and a fluorescent layer formed in the discharge spaces, the partition walls generating a first stress in the lower substrate along a first direction, the reflective layer generating a second stress in the lower substrate along a second direction;
a liquid crystal display panel that displays images by using a light emitted from the surface light source; and
a receiving container that receives the surface light source and the liquid crystal display panel.

21. The apparatus of claim 20, wherein the first direction is opposed to the second direction and the first stress of the lower substrate is compensated by the second stress of the lower substrate.

22. The apparatus of claim 20, wherein the first stress is generated in accordance with a difference between a thermal expansion coefficient of the lower substrate and a thermal expansion coefficient of the partition walls and the second stress is generated in accordance with a difference between the thermal expansion coefficient of the lower substrate and a thermal expansion coefficient of the reflective layer.

23. The apparatus of claim 20, further comprising a voltage applying portion that applies a voltage to the discharge space, wherein the voltage applying portion comprises a plurality of electrodes that surround outer surfaces of at least one of the upper and lower substrates along a direction substantially perpendicular to a longitudinal direction of the partition wall.
